(19) United States
(12) Patent Application Publication
(10) Pub. No.: US 2010/0058422 A1
(43) Pub. Date: Mar. 4, 2010

(54) VIDEO AUDIO STREAM DISTRIBUTION SYSTEM, DISTRIBUTION METHOD, AND DISTRIBUTION PROGRAM

(75) Inventors: Katsuhiro Ochiai, Tokyo (JP); Shuhei Miura, Tokyo (JP); Motonobu Kimura, Tokyo (JP); Kaname Naito, Tokyo (JP); Junichi Sato, Tokyo (JP)

Correspondence Address: YOUNG & THOMPSON, 209 Madison Street, Suite 500, Alexandria, VA, 22314, US

(73) Assignee: NEC CORPORATION, Tokyo (JP)

(21) Appl. No.: 12/523,796

(22) PCT Filed: Jan. 17, 2008
(86) PCT No.: PCT/JP2008/050525

§ 371 Date: Aug. 4, 2009

(30) Foreign Application Priority Data
Jan. 19, 2007 (JP) 2007-010509

(51) Int. Cl. H04N 7/173

(52) U.S. Cl. 725/116; 725/119; 725/126

(57) ABSTRACT

It is possible to provide a video audio stream distribution system, a distribution method, and a distribution program which can improve the stream switching speed during zapping and suppress the actually used network resource in streaming for which QoS is guaranteed. Zapping destination means (211) predicts a stream required for the next distribution request and band managing means (209) instructs only band allocation for the predicted stream to band control means (205) before a distribution request is made by an actual zapping operation.

### TECHNICAL FIELD

The present invention relates to a technique for distributing a video stream, and particularly to a video/audio stream distribution system, a distribution method, and a distribution program

### BACKGROUND ART

Conventionally, in a system that implements a video/audio streaming by means of a unicast operation, in order to implement a broadcast-type service by considering each stream as a TV channel, the securement of a band on a transmission path for transmitting each stream and the setting of filtering (access control) have been performed every time zapping is performed.

For example, when an IPTV service implemented by means of a multicast operation is considered, a band for a core network has a capacity capable of distributing all channels at the same time. However, a band between a terminal and a vendor's local station is not more than 100 Mbps in currently common services so that, assuming that a band used by a single stream is 6 Mbps, only sixteen streams can be distributed at most to the terminal by means of the multicast operation. The effective performance of an ADSL system that is currently prevalent is mostly around 10 Mbps and, in this case, it may be difficult to simultaneously distribute two streams.

Generally, the problem of this type in the conventional technique is caused by the fact that it takes time to switch among video/audio streams during a zapping (means selection of channels on TV by a remote control operation of a user) viewing in which the user switches to another video/audio stream while viewing one video/audio stream so that zapping performance such as that of TV is not obtainable. Particularly, in a QoS-guaranteed video/audio streaming, there is a possibility that operations of the release of a band for a previously viewed video/audio stream and the securement of a band for a video/audio stream to be newly viewed are additionally required when compared to a best-effort video/audio streaming so that the zapping performance is further degraded.

A specific example of the conventional video/audio stream distribution system described above is shown in FIG. 1.

In FIG. 1, the video/audio stream distribution system includes a distribution server 101 for distributing a plurality of video/audio streams, a terminal 107 for transmitting a distribution request for a desired video/audio stream for viewing selected from program information (not shown), and a relay means 103 for receiving the distribution request from the terminal 107 as well as relaying the plurality of video-audio streams to be outputted from the distribution server 101 by means of the multicast operation and distributed to each terminal.

The relay means 103 is provided with a band control means 105 for securing the band for a distribution path between the relay means 103 and the terminal 107, and a band management means 109 for regulating the operation of the band control means 105. In addition reference numerals 102, 104, and 106 denote distribution paths, while reference numerals 108 and 110 denote control lines.

The distribution request for the video/audio stream desired by the user, which is transmitted from the terminal 107, is transferred to the relay means 103 via the distribution path 106, the band control means 105, and the distribution path 104. The relay means 103 transmits a request for securement of a band required for the distribution to the band management means 109 via the control line 110 in accordance with band information on the requested stream (not shown).

In this case, the band management means 109 determines whether or not the requested band can be secured based on a management content. When the requested band can be secured the band management means 109 instructs the band control means 105 to secure the band via the control line 108 and informs the relay means 103 that the band can be secured via the control line 110.

Subsequently, the relay means 103 distributes the video/audio stream requested from the terminal 107 to the terminal 107 by means of a unicast operation via the distribution path 104, the band control means 105, and the distribution path 106.

A technique in view of the problem of the conventional system is disclosed in Patent Document 1. In a method in Patent Document 1, in order to achieve high-speed operation during zapping, some of a plurality of video/audio streams distributed from a distribution server by means of the multicast operation are predicted as streams to be selected next, filtering is performed at a multicast point, and the streams are preliminarily distributed to the terminal. In the case where an instruction for zapping is received from an upper application, when the prediction is correct, the corresponding video/audio stream is selected from among the plurality of video/audio streams that have been already received in the terminal and is played.

In accordance with the method in Patent Document 1, since the streams to be selected next are predicted and preliminarily distributed it is possible to omit the securement of a band and the setting of filtering which are performed every time zapping is performed, and shorten the time required for switching among video/audio streams during zapping viewing to improve the zapping performance.

Patent Document 1: Japanese Patent Application Laid-Open No. 2003-143587

### DISCLOSURE OF THE INVENTION

### Problem To Be Solved By the Invention

However, in the known technique disclosed in Patent Document 1, in addition to the video/audio stream viewed by the user, even the predicted video/audio streams are actually streamed between the multicast point and the terminal. Accordingly, as described above, when the network resource between the multicast point and the terminal is not sufficient due to the ADSL being used, or a plurality of terminals receive the video/audio stream from the same multicast point, the network resource tends to be exhausted. For example, since only one stream with 6 Mbps passes through a line with network throughput of only 10 Mbps, the high-speed operation of zapping cannot be achieved by the method.

It is therefore an exemplary object of the present invention to provide a video/audio stream distribution system a distribution method, and a distribution program which are capable or improving the inconvenience of the conventional technique described above, increasing the stream switching speed during zapping, and suppressing an actually used network resource in the QoS-guaranteed streaming.

### Means For Solving Problem

In order to achieve the foregoing exemplary object, a video/audio stream distribution system in accordance with an exemplary aspect of the present invention is a video/audio stream distribution system including a distribution server for distributing a video/audio stream, a terminal for requesting distribution of a stream selected by a user, a relay means for outputting a request for securement of a band required to distribute the stream of which the distribution is requested, and relaying the distribution of the stream associated with the distribution request from the distribution server to the terminal when the required band is secured, a band management means for outputting an instruction in response to the request for securement of a band from the relay means, and a band control means for securing the band on a transmission path for the stream associated with the distribution request in accordance with the instruction of the band management means, the video/audio stream distribution system further including a zapping destination prediction means provided in the relay means and for predicting a stream associated with a next distribution request continuously made from the terminal, wherein the band management means has a line control information retainment function of preliminarily specifying and retaining line control information indicating that it is possible to secure a hand required to distribute a stream associated with a result of the prediction of the zapping destination prediction means, and the relay means transmits the stream associated with the result of the prediction of the zapping destination prediction means to the terminal of the user when the distribution request therefor is made from the terminal.

In accordance with the video/audio stream distribution system, since the zapping destination prediction means predicts the stream associated with the next distribution request and the band management means specifies and retains information on the band necessary for the predicted stream prior to an actual distribution request, in the QoS-guaranteed streaming, it is already determined whether or not it is possible to secure the band required to view the next stream before the user performs a zapping operation, and it is possible to immediately notify the terminal of the user and increase the stream switching speed during zapping.

In addition, since the predicted stream is not distributed until it is selected during zapping, and only the retainment of the information on the securement of the required band is performed, it is possible to suppress an actually used network resource.

Moreover, since the zapping destination prediction means is provided in the relay means, a conventional terminal and a conventional distribution server can be used and an optimum streaming can be implemented without entailing extra cost or labor to the user using the terminal and a content provider.

Further, in the video/audio stream distribution system described above, the above-mentioned zapping destination prediction means may have a function of predicting a stream in adjacent relation to the stream associated with the distribution request from the terminal as the stream associated with the next distribution request.

With this arrangement, it is possible to predict the stream to be selected next by assuming that the user sequentially switches. One example of streams in adjacent relation includes streams set for previous and subsequent channels when channels that can be ordered are allocated to individual streams from the distribution server.

Furthermore, in the video/audio stream distribution system described above, the above-mentioned band management means may have a function of outputting an instruction in accordance with the line control information on the stream associated with the result of the prediction of the zapping destination prediction means, and the band control means may perform the securement of the band required to distribute the stream associated with the distribution request from the terminal and also preliminarily perform the securement of the band required to distribute the stream associated with the result of the prediction of the zapping destination prediction means.

With this arrangement, since the securement of the band required to view the next stream is already completed before the user performs the zapping operation, it is possible to shorten the time required to secure the band for viewing a new stream.

In addition, in the video/audio stream distribution system described above, the above-mentioned band control means may execute the setting of filtering when the securement of the band required to distribute the stream is executed. With this arrangement, since not only the securement of the band required to view the next stream but also the setting of filtering is already completed prior to the zapping operation, it is possible to increase the stream switching speed during zapping.

Next, a video/audio stream distribution method in accordance with an exemplary aspect of the present invention is a video/audio stream distribution method including a distribution request reception step of receiving a distribution request for a video/audio stream selected by a user from a terminal, a line control information specification step of specifying line control information indicating that it is possible to secure a band required to distribute the stream associated with the distribution request, a resource securement step of performing securement of the band required to distribute the stream associated with the distribution request from the terminal in accordance with the line control information specified by the line control information specification step, and a streaming distribution step of transmitting the stream associated with the distribution request to the terminal using the secured band, the video/audio stream distribution method further including a zapping destination prediction step of predicting a stream associated with a next distribution request made from the terminal, and preliminarily specifying and retaining the line control information required to distribute a stream associated with a result of the prediction, wherein the stream associated with the result of the prediction of the zapping destination prediction step is transmitted to the terminal of the user when the distribution request therefor is made from the terminal.

In the video/audio stream distribution method described above, a stream in adjacent relation to the stream associated with the distribution request from the terminal may be predicted as the stream associated with the next distribution request in the above-mentioned zapping destination prediction step.

In addition, in the video/audio stream distribution method described above, there may be provided a determination step of determining whether or not the stream associated with the distribution request is the stream associated with the result of the prediction at the time of the previous distribution request in the zapping destination prediction step after the above-mentioned distribution request reception step, and there may be provided a distribution step of immediately performing the securement of the required band in accordance with the preliminarily retained line control information for the predicted stream and transmitting the stream associated with the distribution request to the terminal when the stream associated with the distribution request is determined to be the stream associated with the result of the prediction in the determination step instead of the line control information specification step, the resource securement step, and the streaming distribution step.

Moreover, in the video/audio stream distribution method described above, the securement of the band required to distribute the stream associated with the result of the prediction may be performed in accordance with the line control information on the stream associated with the result of the prediction in the above-mentioned zapping destination prediction step, and the stream associated with the distribution request may be transmitted to the terminal using the preliminarily secured band in the distribution step.

In accordance with the video/audio stream distribution method, in the QoS-guaranteed streaming, it is already determined whether or not it is possible to secure the band required to view the next stream or the band is already secured before the user performs the zapping operation so that it is possible to increase the stream switching speed during zapping In addition, since the predicted stream is not distributed until it is actually selected during zapping and only the retainment of the information on the securement of the required band is performed, it is possible to suppress the actually used network resource.

Next, a video/audio stream distribution program in accordance with an exemplary aspect of the present invention is a video/audio stream distribution program causing a computer to execute request input processing for inputting a distribution request for a video/audio stream selected by a user, line control information. specification processing for specifying line control information indicating that it is possible to secure a band required to distribute the stream associated with the distribution request, resource securement processing for performing securement of the band required to distribute the stream associated with the distribution request in accordance with the specified line control information, streaming distribution processing for transmitting the stream associated with the distribution request to the terminal using the secured band, and zapping destination prediction processing for predicting a stream associated with a next distribution request continuously made from the terminal and preliminarily specifying and retaining the line control information required to distribute a stream associated with a result of the prediction.

In addition, in the video/audio stream distribution program described above, the content of the above-mentioned zapping destination prediction processing may be specified so as to predict a stream in adjacent relation to the stream associated with the distribution request from the terminal as the stream associated with the next distribution request.

Moreover, the video/audio stream distribution program described above may cause the computer to execute determination processing for determining whether or not the above-mentioned stream associated with the distribution request is the stream associated with the result of the previous prediction, and execute the resource securement processing of which the content is specified so as to immediately perform the securement of the required band in accordance with the preliminarily retained line control information for the predicted stream and the streaming distribution processing when the stream associated with the distribution request is determined to be the stream associated with the result of the prediction by the determination processing.

Further, in the video/audio stream distribution program described above, the content of the above-mentioned zapping destination prediction processing may be specified so as to preliminarily perform the securement of the band required to distribute the stream associated with the result of the prediction in accordance with the line control information required to distribute the stream associated with the result of the prediction, and the video/audio stream distribution program may cause the computer to execute the streaming distribution processing of which the content is specified so as to transmit the stream associated with the distribution request to the terminal using the preliminarily secured band when the stream is determined to be the stream associated with the result of the prediction by the determination processing.

In accordance with the video/audio stream distribution program, similarly to the video/audio stream distribution method described above, in the QoS-guaranteed streaming, it is already determined whether or not it is possible to secure the band required to view the next stream or the band is already secured before the user performs the zapping operation so that it is possible to increase the stream switching speed during zapping. In addition, since the predicted stream is not distributed until it is actually selected during zapping and only the retainment of the information on the securement of the required band is performed, it is possible to suppress the actually used network resource.

### Effect of the Invention

Since the present invention is thus structured and functions, a possible stream to be viewed next by zapping is thereby predicted based on the adjacent relation of the stream being distributed, and the securement of the band for the predicted stream and the access control are executed prior to the zapping operation by the user. Therefore, in the QoS-guaranteed streaming, the stream switching speed during zapping is increased and, since the predicted stream is not distributed until it is selected during the next zapping and only the securement of the required band is executed, it is possible to suppress the actually used network resource.

### BEST MODE FOR CARRYING OUT THE INVENTION

A description will be given hereinbelow to an exemplary embodiment in the present invention with reference to the drawings.

FIG. 2 is a block diagram showing a structure or a video/audio stream distribution system of the exemplary embodiment in the present invention.

As shown in FIG. 2, the video/audio stream distribution system of the exemplary embodiment is structured to include a distribution server 201 for distributing the video/audio stream, a terminal 207 for transmitting a distribution request for the stream selected by a user, a relay means 203 for outputting a request for a band required to distribute the stream of which the distribution is requested, and relaying the distribution of the stream associated with the distribution request from the distribution server 201 to the terminal 207 when the required band is secured, a band management means 209 for outputting a band securement instruction in response to the request for a band from the relay means 203, a band control means 205 for securing the band on a transmission path for the stream associated with the distribution request in accordance with the instruction of the band management means 209, and a zapping destination prediction means 210 for predicting the stream associated with the next distribution request continuously made from the terminal 207.

In addition, in the video/audio stream distribution system of the exemplary embodiment, the distribution server 201 is connected to the relay means 203 via a distribution path 202, and the relay means 203 is connected to the band control means 205 via a distribution path 204. The band control means 205 is connected to the terminal 207 via a distribution path 206, and the zapping destination prediction means 211 is connected to the relay means 203 via a control line 210 and to the band management means 209 via a control line 212. The band management means 209 is connected to the band control means 205 via a control line 208.

The distribution server 201 has a function of distributing a plurality of video/audio streams to the relay means 203 by means of a multicast operation. A plurality of the distribution servers 201 may be installed, and the streams may be simultaneously distributed from the plurality of distribution servers to the relay means 203. Further, the distribution of the video/audio streams may be performed by means of a unicast operation instead of the multicast operation.

When the user selects a desired video/audio stream by using a remote control or the like, the terminal 207 has a function of determining the selected stream as a desired stream for viewing and transmitting the distribution request for the desired stream for viewing to the relay means 203. Information for identifying the type of the stream is imparted to the request. The terminal 207 also has a function of receiving and playing the video/audio stream transmitted in response to the request.

The relay means 203 has a function of transferring the distribution request from the terminal 207 to the zapping destination prediction means 211 as well as a function of transmitting, among the video/audio streams from the distribution server 201, only the stream associated with the request from the terminal 207 to the terminal 207.

The zapping destination prediction means 211 has a function of referring to the distribution request form the terminal 207 and predicting a stream to be requested next based on a preset regulation. As the preset regulation, there is adopted a regulation in which a stream in adjacent relation to a stream of which the distribution is requested is determined to be a stream to be requested next. With regard to the adjacent relation between streams, an identifier which can be ordered such as an identifiable numerical value, an alphabet, or the like is imparted to each of a plurality of streams distributed by the distribution server 201, and streams having identifiers previous and subsequent to the identifier of a stream being viewed are defined as “streams in adjacent relation to the stream being viewed”. The setting is made such that, when the streams are arranged in ascending or descending order according to the order of the identifiers thereof and the user instructs an operation for forward or reverse running, a stream subsequent to the stream being viewed (forward running) or a stream previous to the stream being viewed (reverse running) is selected according to the sequence of the order of the identifiers.

The adjacent relation includes a case where there is only one stream on each side, for example, a case where the streams indicated by the identifiers “4” and “6” are in adjacent relation to the stream indicated by the identifier “5”, and also includes a case where there are a plurality of streams in adjacent relation on each side, for example, a case where the streams indicated by the identifiers “3” and “4” are in reverse-running adjacent relation to the stream indicated by the identifier “5” and the streams indicated by the identifiers “6” and “7” are in forward-running adjacent relation to the stream indicated by the identifier “5”. It may be determined whether the number of streams in adjacent relation on each side is single or plural according to respective specifications of the distribution paths 204 and 206 between the relay means 203 and the terminal 207, and the band control means 205. That is, in the case of a distribution path design with a limited bandwidth, the number of streams in adjacent relation on each side is limited to one, while in the case of a distribution path design with a sufficient bandwidth, the number of streams in adjacent relation on each side is set to two or three. The reason why the adjacent relation based on the order is used for the prediction is that the user often tries to implement the act of searching for another program by sequentially switching among programs (zapping) as a user's practice instead of using a program search by an EPG (Electronic Program Guide).

The band management means 209 has a line control information retainment function of monitoring the line conditions of the distribution paths 204 and 206 between the relay means 203 and the terminal 207, and preliminarily specifying and retaining line control information indicating that it is possible to secure the communication band required to distribute the video/audio stream associated with the request from the terminal 207 as well as the line control information for distributing the video/audio stream associated with the result of the prediction of the zapping destination prediction means 210. In addition, in order to distribute the video/audio stream associated with the distribution request from the terminal 207 the band management means 209 sends an instruction to the band control means 205 in accordance with the line control information to cause the band control means 205 to execute the securement of the band in the distribution paths 204 and 206 and the setting of filtering. With regard to the line control information on the stream associated with the result of the prediction of the zapping destination prediction means 210, the band management means 209 also sends instructions to the relay means 203 and the band control means 20 in accordance with the line control information to cause them to execute the securement of the band for the predicted stream and the setting of filtering.

The video/audio stream distribution system of the exemplary embodiment is thus structured so that it is possible for the zapping destination prediction means 211 to predict the stream associated with the next distribution request, and is possible to preliminarily perform the securement of the band required to view the next stream before the user performs the zapping operation As a result it is possible to increase the stream switching speed during zapping.

Next, a description will be given to an operation of the exemplary embodiment.

FIG. 3 is a flow chart showing an entire operation of the exemplary embodiment. A description will also be given herein to the video/audio stream distribution in the present invention by showing individual steps.

First, the distribution server 201 distributes a plurality of streams to the relay means 203 by means of the multicast operation (step S301 in FIG. 3). The distribution at this time may be performed by means of the unicast operation instead of the multicast operation. In addition, the relay means 203 may simultaneously receive the stream from another distribution server (not shown).

When a user selects a desired stream by using a remote control or the like, the distribution request for the desired stream for viewing is transmitted from the terminal 207 to the relay means 203 (step S302 in FIG. 3). Information for identifying the type of the stream is imparted to the request. As the information for identifying the stream, a channel number for identifying the stream as a channel, or a URL or an IP address for receiving the stream may be used.

Subsequently, the relay means 203 transfers the distribution request received from the terminal 207 to the zapping destination prediction means 211 (step S303 in FIG. 3, distribution request reception step). The zapping destination prediction means 211 determines whether or not the desired stream for viewing shown in the inputted distribution request coincides with the prediction recorded when the previous request was successful (step S304 in FIG. 3, determination step).

When it is determined that they coincide with each other, the zapping destination prediction means 211 notifies the relay means 203 that the securement of the band is already completed, and the relay means 203 distributes, among a plurality of streams received from the distribution server 201, only the requested desired stream for viewing to the terminal 207 by means of the unicast operation (step S310 in FIG. 3, distribution step). At this time, the distribution may be performed by means of the multicast operation instead of the unicast operation. The multicast distribution in this case is effective when another terminal (not shown) is simultaneously connected to the relay means 203. That is, in a case where the distribution path 204 or 206, or the band control means 205 does not have sufficient band or capability for performing the unicast operation with respect to each of a plurality of terminals, when the same video/audio stream is simultaneously viewed at the plurality of terminals, the same stream may be distributed by means of the multicast operation.

Then, the zapping destination prediction means 211 determines streams in adjacent relation to the desired stream for viewing shown in the distribution request as predicted streams, and issues a request for release of the bands for, among the streams predicted at the previous time, the stream which dose not correspond to the desired stream for viewing at this time, and the stream distributed at the previous time, and a request for securement of the band required to distribute the predicted streams to the band management means 209 (step S311 in FIG. 3).

Subsequently, the band management means 209 specifies the line control information and controls the operation of the band control means 205 in response to the request for securement of a band or the request for release of a band from the zapping destination prediction means 211 (step S312 in FIG. 3, zapping destination prediction step).

When the band management means 209 controls the operation of the band control means 205, in a case where the band control means 205 does not have a sufficient available resource, with regard to the band for the predicted streams, processing for securing a band in a virtual resource is performed. In this case, there may be included processing for preliminarily specifying and retaining the line control information such as the band required to distribute the predicted streams or the like using the band control means 205, and switching to a connection for distributing one of the predicted streams as an actual stream using the band control means 205, the band management means 209, and the zapping destination prediction means 211 such that the predicted stream can be distributed as the actual stream in a stage where the predicted stream is actually determined to be the video/audio stream to be viewed next. For example, when the predicted stream is determined to be the actual stream, the zapping destination prediction means 211 may notify the band management means 209 of the determination, and the band management means 209 may give an instruction for switching to the band control means 205.

As a communication bandwidth required to distribute each stream, an average rate of the corresponding stream obtained from the plurality of streams received in the relay means 203 may be used and, when stream information is additionally provided in advance, the communication bandwidth may be determined by referring to the information.

With regard to the determination step and the zapping destination prediction step described above, a structure may be adopted which programs the contents thereof and causes a computer to execute them.

As the result of the determination shown in the step S304 in FIG. 3, when they do not coincide with each other, the zapping destination prediction means 211 determines the streams in adjacent relation to the desired stream for viewing shown in the distribution request as the predicted streams, and gives the request for release of the band for the streams predicted at the previous time and the request for release of the band currently used by the terminal 207 for the stream reception as well as the request for securement of the bands required to distribute the desired stream for viewing and the predicted streams to the band management means 209 (step S305 in FIG. 3).

Subsequently, the band management means 209 specifies the line control information and controls the operation of the band control means 205 in response to the request for securement of the bands or the requests for release of the bands from the zapping destination prediction means 211 (step S306 in FIG. 3, line control information specification step, resource securement step, and zapping destination prediction step).

When the band management means 209 controls the operation of the band control means 205, in a case where the band control means 205 does not have a sufficient available resource, with regard to the band for the predicted streams, the processing for securing the band in the virtual resource is performed. In this case, there may be included processing for preliminarily specifying and retaining the line control information indicating that it is possible to secure the band required to distribute the predicted streams using the band control means 205, and switching to the connection for distributing one of the predicted streams as the actual stream using the band control means 205, the band management means 209, and the zapping destination prediction means 211 such that the predicted stream can be distributed as the actual stream in a stage where the predicted stream is actually determined to be the video/audio stream to be viewed next.

As the communication bandwidth required to distribute each stream, an average rate of the corresponding stream obtained from the plurality of streams received in the relay means 203 or the like may be used and, when the stream information is additionally provided in advance, the communication bandwidth may be determined by referring to the information.

With regard to the line control information specification step and the resource securement step described above, a structure may be adopted which programs the contents thereof and causes a computer to execute them.

Subsequently, the zapping destination prediction means 211 notifies the relay means 203 of the result of the reception of the request for securement of the band for the desired stream for viewing (step S307 in FIG. 3). Then, the relay means 203 notifies the terminal 207 of the result of the reception of the request for securement of the band for the desired stream for viewing (step S308 in FIG. 3).

When the relay means 203 is notified that the result of the reception in the step S307 is successful, the relay means 203 distributes to the terminal 207 only the requested desired stream for viewing from among the plurality of streams received from the distribution server 201 by means of the unicast operation (step S309 in FIG. 3, streaming distribution step). At this time, the distribution may also be performed by means of the multicast operation instead of the unicast operation.

When the request for securement of the band or the request for release of the band in the step S305 in FIG. 3 is unsuccessful, no instruction may be given to the band control means 205 in the step S308 in FIG. 3. In this case, in the steps S307, S308, and S309, a behavior on the assumption that there was no request related to the desired stream for viewing and the previous and current predicted streams may be performed so that the current reception at the terminal 207 is not interrupted. Even in that case, the failure of the request may be notified in the steps S307 and S308 so that the terminal 207 is notified of the failure.

Filtering processing (access control) for the connected terminal may be performed at the time of securement of the band or release of the band in the above-described flow. For example, in a case where a firewall function is provided in the band control means, when the securement of the band for the corresponding stream is performed, a packet filtering may be set such that the communication between the terminal receiving the stream and the distribution sever transmitting the stream is possible. Similarly, at the time of the release of the band, the packet filtering may be set such that the communication between the terminal receiving the stream and the distribution server transmitting the stream is impossible. In addition, the filtering processing may be performed before, concurrently with, or after the securement of the band and the release of the band.

The request for release of the band and the request for securement of the band performed simultaneously in the steps S305 and S311 are one example of a procedure and the individual requests may be executed separately and orderly. Alternatively, the execution timings thereof may be shifted. For example, in the example of the step S305 in FIG. 3, the request for release of the band for unsuccessfully predicted streams and the request for securement of the band for newly predicted streams may be performed after the relay means 203 is notified of the result of the reception in the step S307 in FIG. 3, and the request for release of the band for the stream currently received by the terminal 207 may also be performed after the step S307, after the step S308, after the step S309, or after the terminal 207 succeeds in receiving a new stream (not shown).

With regard to the streaming distribution step and the distribution step described above, a structure may be adopted which programs the contents thereof and causes a computer to execute them.

In accordance with the system of the exemplary embodiment that has thus been described in the QoS-guaranteed streaming, the securement of the band required to view the next stream is already completed before the user performs the zapping operation so that it is possible to immediately distribute the stream to the terminal 207 during the zapping operation and increase the stream switching speed during zapping.

In addition, since the predicted stream is not distributed until it is selected during zapping, and only the securement of the required band is executed, it is possible to suppress the actually used network resource. Conventional terminals and servers can be used for the terminal 207 and the distribution server 201 so that it is possible to implement an optimum streaming without entailing extra cost or labor to the user using the terminal 207 and a content provider.

### EXAMPLE 1

Next, a description will be given to a specific example of the present invention by showing the operation thereof. FIG. 4 is a view showing the structure of the system of the example 1. FIG. 5 is a view showing a remote control 501 for controlling the operation of an IPTV receiving terminal 408 in the example.

An IPTV distribution server 401 as the distribution server is transmitting twelve video/audio streams A to L (not shown) to a multicast termination unit 404 as the relay means by means of the multicast operation It is assumed that the video/audio stream currently received by the IPTV receiving terminal 408 as the terminal is the video/audio stream C, the video/audio streams B and D are predicted at the time of the previous operation of the remote control 501, and the securement of the band for the video/audio streams B and D is already completed

When a user operates the remote control 501 to press down a channel forward-running button 504, the IPTV receiving terminal 408 transmits a request for viewing the video/audio stream D to the multicast termination unit 404. The multicast termination unit 404 transfers the request for viewing to a zapping destination prediction unit 410 as the zapping destination prediction means.

At the time of reception of the previous request for viewing, the video/audio stream D is determined to be the predicted stream by the zapping destination prediction unit 410, and the securement of the band required for distribution via a router 406 as the band control means and the access control are already completed. Therefore, the zapping destination prediction unit 410 notifies the multicast termination unit 404 of band securement completion information.

On receiving the band securement completion information notified by the zapping destination prediction unit 410, the multicast termination unit 404 stops the transmission of the video/audio stream C currently transmitted to the IPTV receiving terminal 408 by means of the unicast operation via the router 406, and starts the transmission of the video/audio stream D instead.

The IPTV receiving terminal 408 starts the reception of the new video/audio stream D and plays it.

Subsequently the zapping destination prediction unit 410 sets the video/audio streams C and E which are in adjacent relation to the video/audio stream D as the predicted streams. Next, the zapping destination prediction unit 410 issues the request for securement of the band required to distribute the video/audio streams C to E and the request for setting to make access possible (the securement of the band and the setting are continued for the video/audio streams C and D, while they are newly requested for the video-audio stream E), and the request for release of the band for the video/audio stream B which is no longer necessary and the request for setting to make access impossible to a resource reception control server 412 as the band management means.

In response to the requests from the zapping destination prediction unit 410, the resource reception control server 412 issues the request for release of the band for the video/audio stream B and the request for setting to make access impossible, and the request for securement of the band for the video/audio streams C to E (the securement of the band is continued for the video/audio streams C and D, while it is newly requested for the video/audio stream E) and the request for setting to make access possible to the router 406. It is assumed herein that a success of the reception of the request is returned from the router 406 in response to the requests. Accordingly, the resource reception control server 412 transmits the success of the reception of the request to the zapping destination prediction unit 410.

Since the zapping destination prediction unit 410 has received the success of the reception of the request from the resource reception control server 412, the zapping destination prediction unit 410 determines the video/audio stream D that is newly being viewed and the video/audio streams C and E adjacent thereto, of which the requests have been issued to the resource reception control server 412, and transmits the success of the reception of the request to the multicast termination unit 404.

The zapping destination prediction unit 410 in the example may be included in the resource reception control server 412 instead of a relay device 403. In this case, when the request for viewing from the IPTV receiving terminal 408 is received in the multicast termination unit 404, the request for viewing is issued to the zapping destination prediction unit 410 in the resource reception control server 412. Similarly, the zapping destination prediction unit 410 issues the request for securement of the band and the request for the access setting to a management unit for the band and the access (not shown) in the resource reception control server 412.

Although the example has described the case where one IPTV receiving terminal is connected, the example is not limited thereto. A plurality of IPTV receiving terminals may be connected to the relay device 403 at the same time, and the IPTV receiving terminals in this case are assumed to function similarly to the IPTV receiving terminal 408. In addition, the router 406 may be adapted to be capable of simultaneously controlling the requests for viewing, the responses, and the video/audio streams of the plurality of IPTV receiving terminals.

Moreover, a plurality of video/audio streams transmitted from the IPTV distribution server 401 by means of the multicast operation may be simultaneously received by a plurality of relay devices, and one or more IPTV receiving terminals may be connected to each of the relay devices. Each of the relay devices in this case is assumed to function similarly to the relay device 403, and each of the IPTV receiving terminals is assumed to function similarly to the IPTV receiving terminal 408.

Further, when the request for viewing, the response, and the video/audio stream between the relay device 403 and the IPTV receiving terminal 408 are considered to be one session, the router 406 may be adapted to be capable of simultaneously controlling a plurality of sessions occurring at the plurality of relay devices and the plurality of IPTV receiving terminals.

Furthermore, when a plurality of routers 406 are installed and each of the plurality of routers controls one or more sessions, the plurality of installed routers may be controlled by one resource reception control server 412, or may be controlled by a plurality of resource reception control servers. In this case, the zapping prediction unit 410 is assumed to have a method for specifying the resource reception control server 412 which manages the router 406 controlling the session thereof. The method for specifying the resource reception control server 412 may be implemented by using a method which permanently retains an address in a boot configuration file or the like. When the zapping destination prediction unit 410 is located in the resource reception control server 412, the multicast termination unit 404 is assumed to have a method for specifying the zapping destination prediction unit in the resource reception control server 412 which manages the router 406 controlling the session thereof. The method for specifying the zapping destination prediction unit may also be implemented by using the method which permanently retains an address in a boot configuration file or the like.

In addition, the video/audio stream which is distributed from the IPTV distribution server 401 to the multicast termination unit 404 may be distributed by means of the unicast operation instead of the multicast operation

Moreover, the relay device 403 may be connected to a plurality of IPTV distribution servers, receive the video/audio streams from the individual servers at the same time, and transmit to the IPTV receiving terminal 408, among the video/audio streams, the video/audio stream of which the request for viewing is made from the IPTV receiving terminal 408.

Further, the request for securement of the band, the request for release of the band, and the request for setting of the access control to the resource reception control server 412 may be performed by the multicast termination unit 404 instead of the zapping destination prediction unit 410. In this case, when the predicted video/audio stream is set by the zapping destination prediction unit 410, an operation is performed in which the information on the setting is returned to the multicast termination unit 404, and the multicast termination unit 404 transmits the request for securement of the required band, the request for release of the band, and the request for setting of the access control to the resource reception control server 412 by using the information and receives the reply.

In accordance with the system of the example described thus far, in the QoS-guaranteed streaming, the securement of the band required to view the next stream is already completed before the user performs the zapping operation so that it is possible to immediately distribute the stream to the IPTV receiving terminal 408 during the zapping operation and increase the stream switching speed during zapping.

In addition, since the predicted stream is not distributed until it is actually selected during zapping and only the securement of the required band is executed, it is possible to suppress the actually used network resource. As the IPTV receiving terminal 408 and the IPTV distribution server 401, conventional ones can be used so that it is possible to implement an optimum streaming without entailing extra cost or labor to the user using the IPTV receiving terminal 408 and a content provider.

This application is based upon and claims the benefit of priority from Japanese patent application No. 2007-010509, filed on Jan. 19, 2007, the disclosure of which is incorporated herein in its entirety by reference.

### BRIEF DESCRIPTION OF THE DRAWINGS

FIG. 1 is a block diagram showing an entire structure of an embodiment of a conventional technique;

FIG. 2 is a block diagram showing an entire structure of an exemplary embodiment of the present invention;

FIG. 3 is a flow chart showing an operation of the exemplary embodiment disclosed in FIG. 2;

FIG. 4 is a block diagram showing a structure of an example of the present invention; and

FIG. 5 is a view showing a structure of a remote control in the example disclosed in FIG. 4.

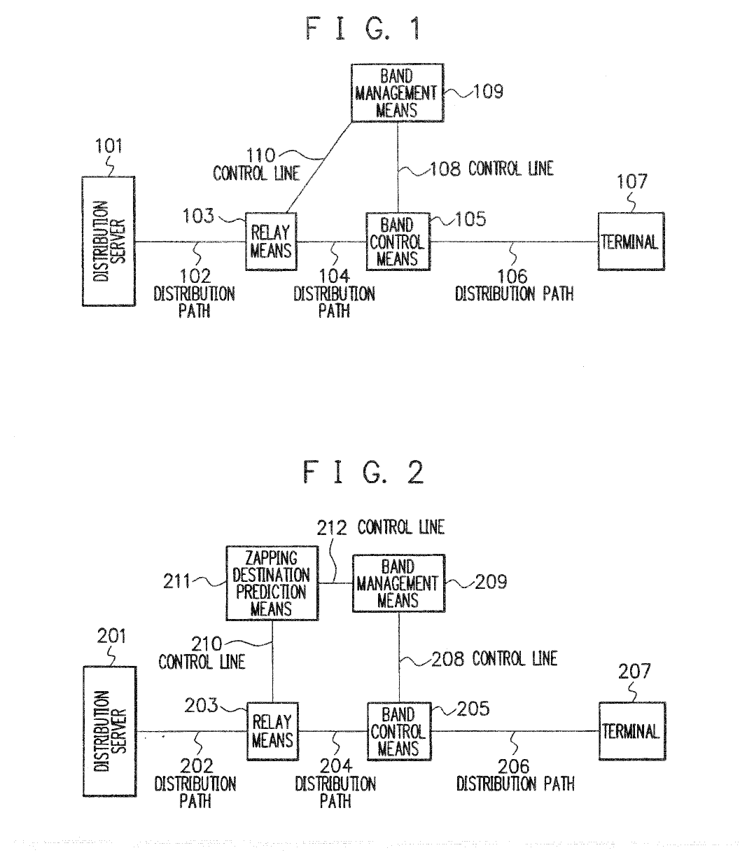

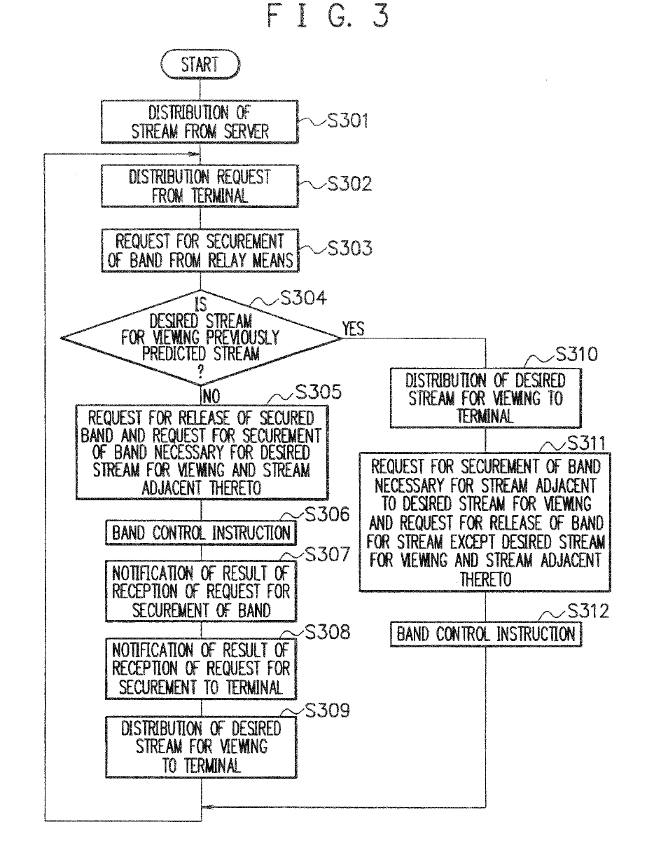

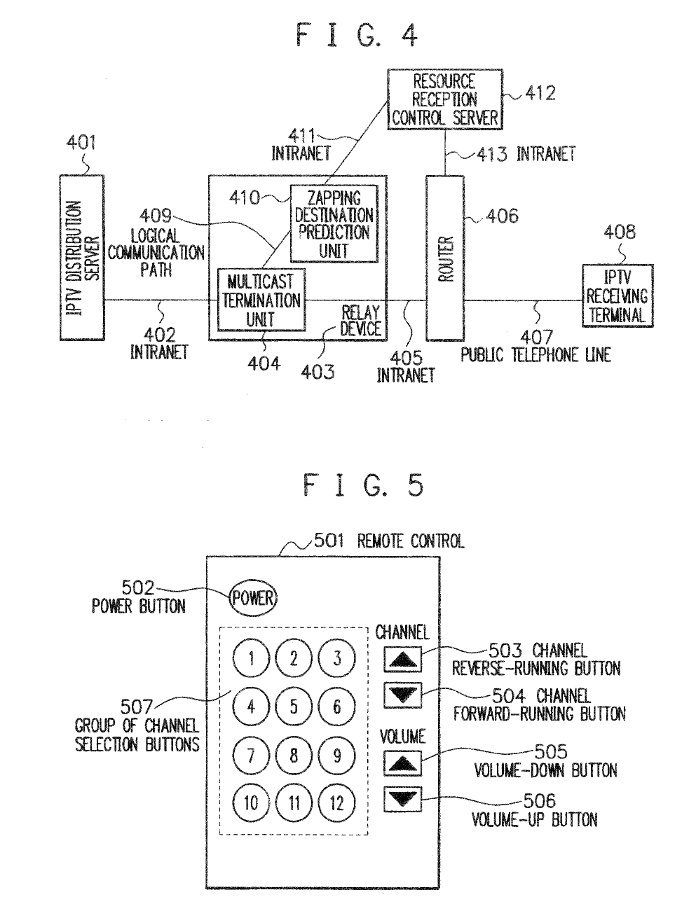

### EXPLANATIONS OF LETTERS OR NUMERALS

101, 201 distribution server
102, 104, 106, 202, 204, 206 distribution path
103, 203 relay means
105, 205 band control means
107, 207 terminal
108, 110, 208, 210, 212 control line
109, 209 band management means
211 zapping destination prediction means
401 IPTV distribution server
402, 405, 411 intranet
403 relay device
404 multicast termination unit
406 router
407 public telephone line
408 IPTV receiving terminal
409 logical communication path
410 zapping destination prediction unit
412 resource reception control server
501 remote control
502 power button
503 channel reverse-running button
504 channel forward-running button
505 volume-down button
506 volume-up button
507 group of channel selection buttons

1-12. (canceled)

13. A video/audio stream distribution system, comprising:
a distribution server for distributing a video/audio stream;
a terminal for requesting distribution of a stream selected by a user;
a relay unit which outputs a request for securement of a band required to distribute the stream of which the distribution is requested, and relays the distribution of the stream associated with the distribution request from the distribution server to the terminal when the required band is secured;
a band management unit which outputs an instruction in response to the request for securement of a band from the relay unit; and
a band control unit which secures the band on a transmission path for the stream associated with the distribution request in accordance with the instruction of the band management unit,
the video/audio stream distribution system further comprising:
a zapping destination prediction unit provided in the relay unit and which predicts a stream associated with a next distribution request continuously made from the terminal, wherein
the band management unit has a line control information retainment function of preliminarily specifying and retaining line control information indicating that it is possible to secure a band required to distribute a stream associated with a result of the prediction of the zapping destination prediction unit, and the relay unit transmits the stream associated with the result of the prediction of the zapping destination prediction unit to the terminal of the user when the distribution request therefor is made from the terminal.

14. The video/audio stream distribution system of claim 13, wherein the zapping destination prediction unit has a function of predicting a stream in adjacent relation to the stream associated with the distribution request from the terminal as the stream associated with the next distribution request.

15. The video/audio stream distribution system of claim 13, wherein the band management unit has a function of outputting the instruction in accordance with the line control information on the stream associated with the result of the prediction of the zapping destination prediction unit, and the band control unit performs the securement of the band required to distribute the stream associated with the distribution request from the terminal and also preliminarily performs the securement of the band required to distribute the stream associated with the result of the prediction of the zapping destination prediction unit.

16. The video/audio stream distribution system of claim 13, wherein the band control unit also performs a setting of filtering as well as the securement of the band required to distribute the stream.

17. A video/audio stream distribution method in a video/audio stream distribution system comprising:
a distribution server for distributing a video/audio stream;
a terminal for requesting distribution of a stream selected by a user;
a relay unit which outputs a request for securement of a band required to distribute the stream of which the distribution is requested and relays the distribution of the stream associated with the distribution request from the distribution server to the terminal when the required band is secured;
a band management unit which outputs an instruction in response to the request for securement of a band from the relay unit; and
a band control unit which secures the band on a transmission path for the stream associated with the distribution request in accordance with the instruction of the band management unit,
the video/audio stream distribution method comprising:
a distribution request reception step of receiving the distribution request for the stream selected by the user from the terminal;
a line control information specification step of outputting the request for securement of the band required to distribute the stream of which the distribution is requested from the relay unit, and specifying line control information indicating that it is possible to secure the band required to distribute the stream associated with the distribution request in response to the request for securement of a band from the relay unit;
a resource securement step of performing the securement of the band required to distribute the stream associated with the distribution request from the terminal in accordance with the line control information specified by the line control information specification step; and
a streaming distribution step of relaying the distribution of the stream associated with the distribution request from the distribution server to the terminal using the secured band by means of the relay unit,
the video/audio stream distribution method further comprising:
a zapping destination prediction step of predicting a stream associated with a next distribution request made from the terminal using a zapping destination prediction unit provided in the relay unit; and
a line control information retainment step of preliminarily specifying and retaining the line control information indicating that it is possible to secure the band required to distribute a stream associated with a result of the prediction, wherein
the relay unit transmits the stream associated with the result of the prediction of the zapping destination prediction step to the terminal of the user when the distribution request therefor is made from the terminal.

18. The video/audio stream distribution method of claim 17, wherein, in the zapping destination prediction step, a stream in adjacent relation to the stream associated with the distribution request from the terminal is predicted as the stream associated with the next distribution request.

19. The video/audio stream distribution method of claim 17, further comprising:
a determination step of determining whether or not the stream associated with the distribution request is a stream associated with the result of the prediction at a time of a previous distribution request in the zapping destination prediction step, the determination step provided after the distribution request reception step, and
a distribution step of immediately performing the securement of the required band in accordance with the preliminarily retained line control information for the predicted stream and transmitting the stream associated with the distribution request to the terminal when the stream associated with the distribution request is determined to be the stream associated with the result of the prediction in the determination step, the distribution step provided instead of the line control information specification step, the resource securement step, and the streaming distribution step.

20. The video/audio stream distribution method of claim 19, wherein, in the zapping destination prediction step, the securement of the band required to distribute the stream associated with the result of the prediction is performed in accordance with the line control information on the stream associated with the result of the prediction and, in the distribution step, the stream associated with the distribution request is transmitted to the terminal using the preliminarily secured band.

21. A storage medium for storing a video/audio stream distribution program in a video/audio stream distribution system comprising:
a distribution server for distributing a video/audio stream;
a terminal for requesting distribution of a stream selected by a user;
a relay unit which outputs a request for securement of a band required to distribute the stream of which the distribution is requested and relays the distribution of the stream associated with the distribution request from the distribution server to the terminal when the required band is secured;
a band management unit which outputs an instruction in response to the request for securement of a band from the relay unit; and
a band control unit which secures the band on a transmission path for the stream associated with the distribution request in accordance with the instruction of the band management unit,
the video/audio stream distribution program causing a computer to execute:
request input processing for inputting the distribution request for the video/audio stream selected by the user;
line control information specification processing for outputting the request for securement of the band required to distribute the stream of which the distribution is requested from the relay unit and specifying line control information indicating that it is possible to secure the band required to distribute the stream associated with the distribution request in response to the request for securement of a band from the relay unit;
resource securement processing for performing the securement of the band required to distribute the stream associated with the distribution request in accordance with the specified line control information; and
streaming distribution processing for relaying the distribution of the stream associated with the distribution request from the distribution server to the terminal using the secured band by means of the relay unit,
the video/audio stream distribution program further causing the computer to execute:
zapping destination prediction processing for predicting a stream associated with a next distribution request continuously made from the terminal using a zapping destination prediction unit provided in the relay unit; and
line control information retainment processing for preliminarily specifying and retaining the line control information indicating that it is possible to secure the band required to distribute a stream associated with a result of the prediction.

22. The storage medium for storing the video/audio stream distribution program of claim 21, wherein a content of the zapping destination prediction processing is specified so as to predict a stream in adjacent relation to the stream associated with the distribution request from the terminal as the stream associated with the next distribution request.

23. The storage medium for storing the video/audio stream distribution program of claim 21, wherein the computer is caused to execute determination processing for determining whether or not the stream associated with the distribution request is a stream associated with the result of a previous prediction and, when the stream associated with the distribution request is determined to be the stream associated with the result of the prediction by the determination processing, the computer is caused to execute the resource securement processing of which the content is specified so as to immediately perform the securement of the required band in accordance with the preliminarily retained line control information for the predicted stream and the streaming distribution processing.

24. The storage medium for storing the video/audio stream distribution program of claim 21, wherein the content of the zapping destination prediction processing is specified so as to preliminarily perform the securement of the band required to distribute the stream associated with the result of the prediction in accordance with the line control information required to distribute the stream associated with the result of the prediction and, when the stream associated with the distribution request is determined to be the stream associated with the result of the prediction by the determination processing, the computer is caused to execute the streaming distribution processing of which the content is specified so as to transmit the stream associated with the distribution request to the terminal using the preliminarily secured band.

25. A video/audio stream distribution system, comprising:
a distribution server for distributing a video/audio stream;
a terminal for requesting distribution of a stream selected by a user;
a relay means for outputting a request for securement of a band required to distribute the stream of which the distribution is requested, and relaying the distribution of the stream associated with the distribution request from the distribution server to the terminal when the required band is secured;
a band management means for outputting an instruction in response to the request for securement of a band from the relay means; and
a band control means for securing the band on a transmission path for the stream associated with the distribution request in accordance with the instruction of the band management means,
the video/audio stream distribution system further comprising:
a zapping destination prediction means provided in the relay means and for predicting a stream associated with a next distribution request continuously made from the terminal, wherein
the band management means has a line control information retainment function of preliminarily specifying and retaining line control information indicating that it is possible to secure a band required to distribute a stream associated with a result of the prediction of the zapping destination prediction means, and the relay means transmits the stream associated with the result of the prediction of the zapping destination prediction means to the terminal of the user when the distribution request therefor is made from the terminal.

26. The video/audio stream distribution system of claim 14, wherein the band management unit has a function of outputting the instruction in accordance with the line control information on the stream associated with the result of the prediction of the zapping destination prediction unit, and the band control unit performs the securement of the band required to distribute the stream associated with the distribution request from the terminal and also preliminarily performs the securement of the band required to distribute the stream associated with the result of the prediction of the zapping destination prediction unit.

27. The video/audio stream distribution system of claim 14, wherein the band control unit also performs a setting of filtering as well as the securement of the band required to distribute the stream.

28. The video/audio stream distribution system of claim 15, wherein the band control unit also performs a setting of filtering as well as the securement of the band required to distribute the stream.

29. The video/audio stream distribution method of claim 18, further comprising:
a determination step of determining whether or not the stream associated with the distribution request is a stream associated with the result of the prediction at a time of a previous distribution request in the zapping destination prediction step, the determination step provided after the distribution request reception step, and
a distribution step of immediately performing the securement of the required band in accordance with the preliminarily retained line control information for the predicted stream and transmitting the stream associated with the distribution request to the terminal when the stream associated with the distribution request is determined to be the stream associated with the result of the prediction in the determination step, the distribution step provided instead of the line control information specification step, the resource securement step, and the streaming distribution step.

30. The storage medium for storing the video/audio stream distribution program of claim 22, wherein the computer is caused to execute determination processing for determining whether or not the stream associated with the distribution request is a stream associated with the result of a previous prediction and, when the stream associated with the distribution request is determined to be the stream associated with the result of the prediction by the determination processing, the computer is caused to execute the resource securement processing of which the content is specified so as to immediately perform the securement of the required band in accordance with the preliminarily retained line control information for the predicted stream and the streaming distribution processing.

31. The storage medium for storing the video/audio stream distribution program of claim 22, wherein the content of the zapping destination prediction processing is specified so as to preliminarily perform the securement of the band required to distribute the stream associated with the result of the prediction in accordance with the line control information required to distribute the stream associated with the result of the prediction and, when the stream associated with the distribution request is determined to be the stream associated with the result of the prediction by the determination processing, the computer is caused to execute the streaming distribution processing of which the content is specified so as to transmit the stream associated with the distribution request to the terminal using the preliminarily secured band.
